(19) United States
(12) Patent Application Publication
(10) Pub. No.: US 2011/0264927 A1
(43) Pub. Date: Oct. 27, 2011

(54) MOBILE COMPUTING MANAGEMENT AND STORAGE DEVICE

(75) Inventors: Timothy Dearborn, Saugatuck, MI (US); Paul Doczy, Austin, TX (US); Kurt M. H. Heggland, Austin, TX (US); Theodore B. Pasquale, Austin, TX (US)

(73) Assignee: Dell Products L.P., Round Rock, TX (US)

(21) Appl. No.: 12/768,098

(22) Filed: Apr. 27, 2010

(51) Int. Cl. G06F 1/26; G06F 13/00

(52) U.S. Cl. 713/300; 710/303

(57) ABSTRACT

A mobile computing management and storage device configured as a portable information handling system (IHS) storage device includes a frame and a docking station supported by the frame. The docking station includes a plurality of channels configured to receive a plurality of portable IHSs. The channels include a power coupling plug and a communication coupling plug such that the power coupling plug and the communication coupling plug are configured and positioned with respect to the channels to mate with corresponding power and communication couplings of the plurality of portable IHSs when the plurality of IHSs are engaged in the plurality of channels. The device further includes a power supply system supported by the frame and electrically coupled to the power coupling(s). The power supply system is configured to provide staged charging when a plurality of portable IHSs are stored in the docking station. In addition, the device includes a communication switching system supported by the frame and communicatively coupled to the communication coupling(s) such that the communication coupling(s) provide communication signals to the plurality of portable IHSs when stored in the docking station.

### BACKGROUND

The present disclosure relates generally to information handling systems (IHSs), and more particularly to a mobile computing management and storage device for IHSs.

As the value and use of information continues to increase, individuals and businesses seek additional ways to process and store information. One option is an IHS. An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

In a classroom, office or other group setting, it may be desirable to have many IHSs configured the same and also configured to store in a mating cabinet or cart for security and charging purposes. Traditional IHS storage/charging carts open on one side to allow access to the IHSs stored inside. Thus, having only one sided access to the IHSs, it slows the process for users of the IHSs to retrieve and store their IHS in the cart. Additionally, traditional IHS storage/charging carts have individual power adaptor cables for charging the portable IHSs. Thus, the user of the IHS has to locate the dedicated power adaptor lead for the bay in which they want to store their IHS and then plug it into the power adaptor input socket of the IHS before returning the IHS to a bay within the cart. This complicates and slows the storage process for the IHSs in the storage/charging cart.

Accordingly, it would be desirable to provide an improved mobile computing management and storage device for IHS storage, charging and maintenance.

### SUMMARY

According to one embodiment, a mobile computing management and storage device configured as a portable information handling system (IHS) storage device includes a frame and a docking station supported by the frame. The docking station includes a plurality of channels configured to receive a plurality of portable IHSs. The channels include a power coupling plug and a communication coupling plug such that the power coupling plug and the communication coupling plug are configured and positioned with respect to the channels to mate with corresponding power and communication couplings of the plurality of portable IHSs when the plurality of IHSs are engaged in the plurality of channels. The device further includes a power supply system supported by the frame and electrically coupled to the power coupling(s). The power supply system is configured to provide staged charging when a plurality of portable IHSs are stored in the docking station. In addition, the device includes a communication switching system supported by the frame and communicatively coupled to the communication coupling(s) such that the communication coupling(s) provide communication signals to the plurality of portable IHSs when stored in the docking station.

### BRIEF DESCRIPTION OF THE DRAWINGS

FIG. 1 illustrates an embodiment of an information handling system (IHS).

FIG. 2 illustrates an isometric view of an embodiment of a mobile computing management and storage device for IHS storage, according to an embodiment of the present disclosure.

FIG. 3 illustrates another isometric view of an embodiment of a mobile computing management and storage device for IHS storage with access doors open, according to an embodiment of the present disclosure.

FIG. 4 illustrates an isometric end view of an embodiment of a mobile computing management and storage device for IHS storage, according to an embodiment of the present disclosure.

FIG. 5 illustrates another isometric end view of an embodiment of a mobile computing management and storage device for IHS storage, according to an embodiment of the present disclosure.

FIG. 6 illustrates an isometric cut-away view of an embodiment of a mobile computing management and storage device for IHS storage, according to an embodiment of the present disclosure.

FIG. 7 illustrates an isometric view of an embodiment of a docking station, according to an embodiment of the present disclosure.

FIG. 8 illustrates another isometric view of an embodiment of a docking station, according to an embodiment of the present disclosure.

FIG. 9 illustrates a close-up isometric view of a portion of a mobile computing management and storage device for IHS storage having a status indicator, according to an embodiment of the present disclosure.

FIG. 10 illustrates another isometric view of an embodiment of a mobile computing management and storage device for IHS storage, according to an embodiment of the present disclosure.

FIG. 11 illustrates an isometric view of an embodiment of a docking station in a mobile computing management and storage device for IHS storage, according to an embodiment of the present disclosure.

FIG. 12 illustrates an isometric view of an embodiment of a docking station holding a plurality of IHSs in a mobile computing management and storage device for IHS storage, according to an embodiment of the present disclosure.

FIG. 13 illustrates an exploded view of handle assembly for an embodiment of a mobile computing management and storage device for IHS storage, according to an embodiment of the present disclosure.

FIG. 14 illustrates an isometric view of cable connections for an embodiment of a mobile computing management and storage device for IHS storage, according to an embodiment of the present disclosure.

FIG. 15 illustrates an isometric view of a portable IHS, according to an embodiment of the present disclosure.

FIG. 16 illustrates a screen shot of an embodiment of a maintenance application to provide updates to the IHSs, according to an embodiment of the present disclosure.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. An IHS 100 may be stationary and include multiple components or may include integrated components integrated together in a portable shell. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

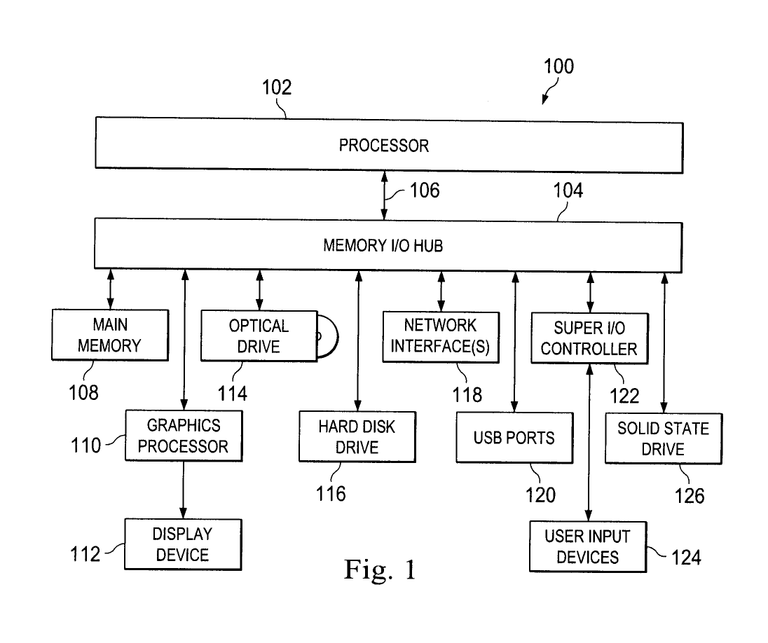

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

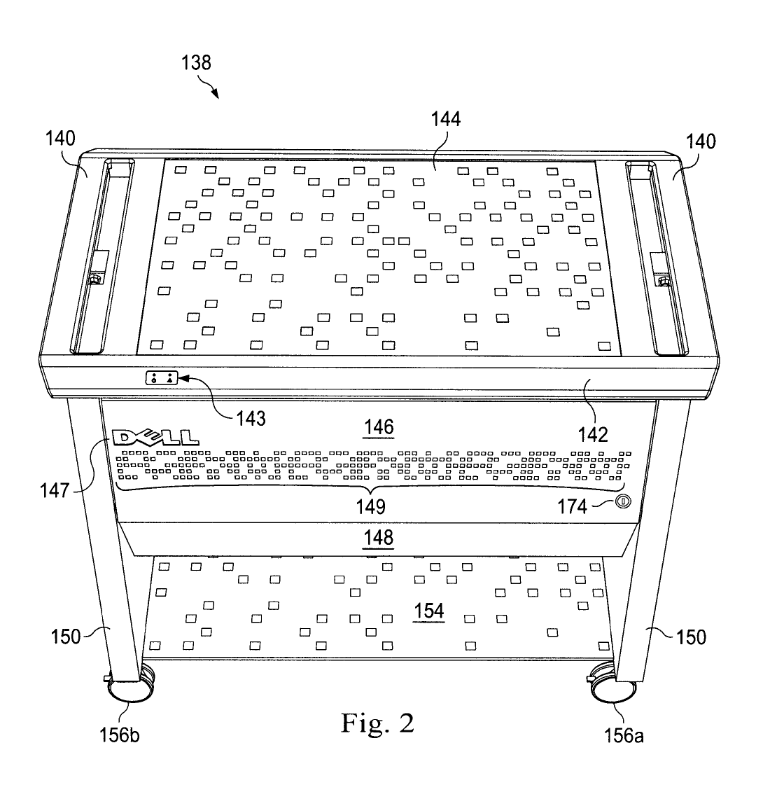

A plurality of IHSs 100 may be configured to mate with a corresponding mobile computing management and storage device, such as the storage cart 138 (see FIGS. 2-14), that stores, secures, networks and charges the plurality of the IHSs. For example, the cart 138 may mate with and store 24 IHSs, such as the Dell Latitude 2100 standard and/or touch screen notebooks, or any other portable IHSs configured to mate within the architecture of the cart 138. An embodiment of the cart is configured so that a user does not interface with cables or cords that are required on conventional IHS storage carts to plug-in (e.g., for power or communication) each individual IHS 100 stored in the cart 138. A feature of the cart 138 provides that a user simply slides the IHS 100 into a storage docking station. When the IHS 100 is fully seated in the docking station, the cart 138 provides electrical power and communications (e.g., Ethernet via a standard RJ45 connector) to the IHS without a user having to physically couple a power cable and a communication cable to each IHS 100 stored in the cart 138.

By eliminating the need to individually plug in each power and Ethernet cable found on traditional storage devices, embodiments of the present disclosure reduce the amount of time it takes to store and deploy the IHSs 100 to and from the cart 138. Examples of uses for the IHS 100/cart 138 system may be in classroom and/or office settings. In an embodiment the cart 138 may be configured as a 2-sided cart, which allows twice the number of users to access the storage bays, which further speeds deployment and storage of the IHSs 100 with the cart 138.

IHS charging devices and communication networking devices may be hidden from view in a secondary locking door located below an upper IHS storage bay door. An embodiment may optionally include a wireless communication router (e.g., an access point) supported by the frame of the cart 138 to provide communication functionality to the users of the IHSs 100 when they are removed from the cart 138 and used. While traditional IHS charging carts use multiple external power cords to receive enough electrical power for charging such a large number of portable IHSs, an embodiment of the cart 138 of the present disclosure includes a power management distribution system so that only a single external electrical power cord is used to charge all stored IHSs 100. For example, the power management distribution system may allow 24 portable IHSs 100 to be charged using a distribution cycle timer to spread the available electrical power to groups of IHSs 100 and rotate to different groups of IHSs 100 until all of the stored IHSs 100 are fully charged.

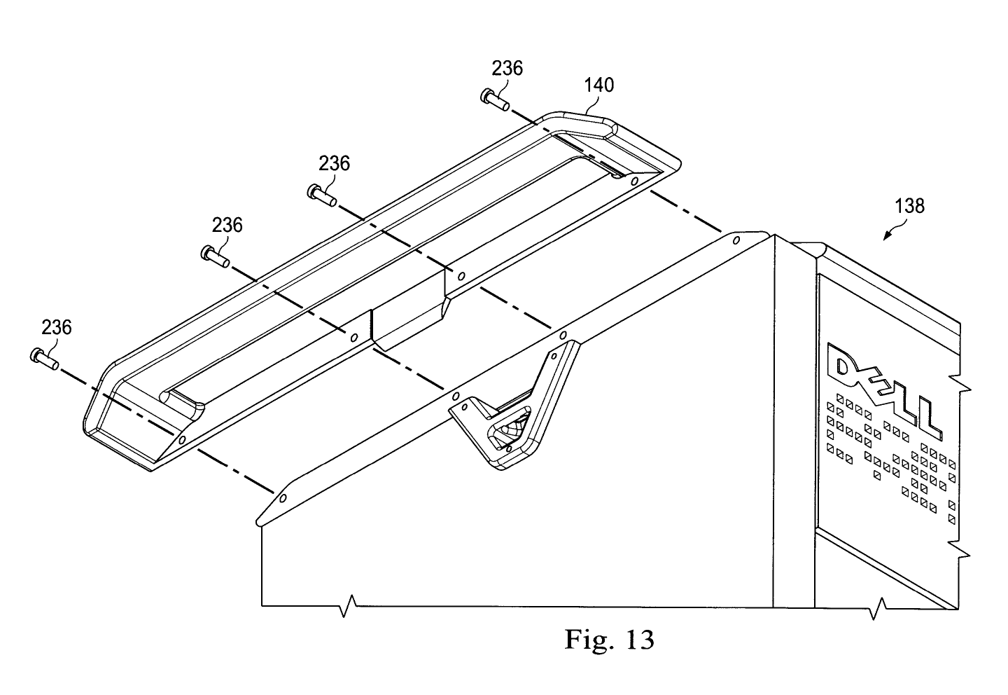

Turning now to FIGS. 2-14, FIG. 2 illustrates an isometric view of an embodiment of a the mobile computing management and storage device (e.g., cart 138) configured to hold a plurality of IHSs 100. As discussed above, the cart 138 provides storage, charging and communications for a plurality of IHSs 100, when they are stored within the body of the cart 138. As shown, the cart 138 includes a support structure or frame assembled from multiple components. Attached to the frame are handles 140 extending outward from opposite ends of an upper portion of the frame. The handles 140 may be ergonomically shaped, molded from plastic material, and fastened to the cart 138 (see also FIG. 13). The upper portion of the cart 138 also includes a top cover 142 attached at upper front and rear portions of the frame. The top cover 142 may also be molded from plastic material and fastened to the frame. In an embodiment, the top cover 142 includes a status indicator 143 light/display for providing status of operations for the cart 138. For example, the status indicator 143 may be configured as a power/fault status indicator, which displays fault and power status of the cart 138. The upper surface 144 of the cart 138 may be used as a work surface and may be covered with a rubber/silicone mat. The mat may be an anti-skid rubber/silicone mat to reduce slipping of items on the surface 144. The upper surface 144 may be configured to support a weight capacity of approximately 25 lbs (11.4 kg). However, other materials and weight capacities may be used with the present disclosure.

The cart 138 includes an upper compartment door 146 on a front portion of the cart 138. The cart 138 may also include a similar door on a rear portion of the cart 138 for storing IHSs 100 in the rear of the cart 138. The door 146 is formed from sheet steel and coated with paint or powder coating. The door 146 is retractable and pivots upward and into the frame of the cart 138 for storage under the upper work surface 144, thereby allowing unobstructed access to the IHSs 100 stored inside the cart 138. When closed, the upper doors 146 overlap lower doors 148 and conceal locks on the lower doors 148. The lower compartment doors 148 (e.g., one on the front portion of the cart 138 and one on the rear portion of the cart 138) are lockable, hinged doors formed from sheet metal and coated with paint or powder coating. When the lower compartment doors 148 are closed, AC adapters and a controller box inside the lower compartment are concealed from view. The doors 146, 148 may include a name label or logo 147, venting holes 149, and/or a keyed lock 174. Upper and lower compartment doors 146, 148 may all include keyed locks that all open with same key.

The frame of the cart 148 is formed using the upper surface 144 and a lower shelf 154 between side panels 150. The side panels 150 are formed from sheet steel and coated with paint or powder coating. The lower shelf 154 may also be covered using an anti-skid mat similar to the mat discussed above. The lower shelf 154 may be configured to support a weight capacity of approximately 25 lbs (11.4 kg). However, other materials and weight capacities may be used with the present disclosure. At a lower portion of the side panels 150 are rotating casters 156a and fixed casters 156b (discussed as 156 for brevity). The casters 156 rotate and allow the cart 138 to be easily moved from place to place. The casters 156 may be locked to prevent rolling of the cart 138.

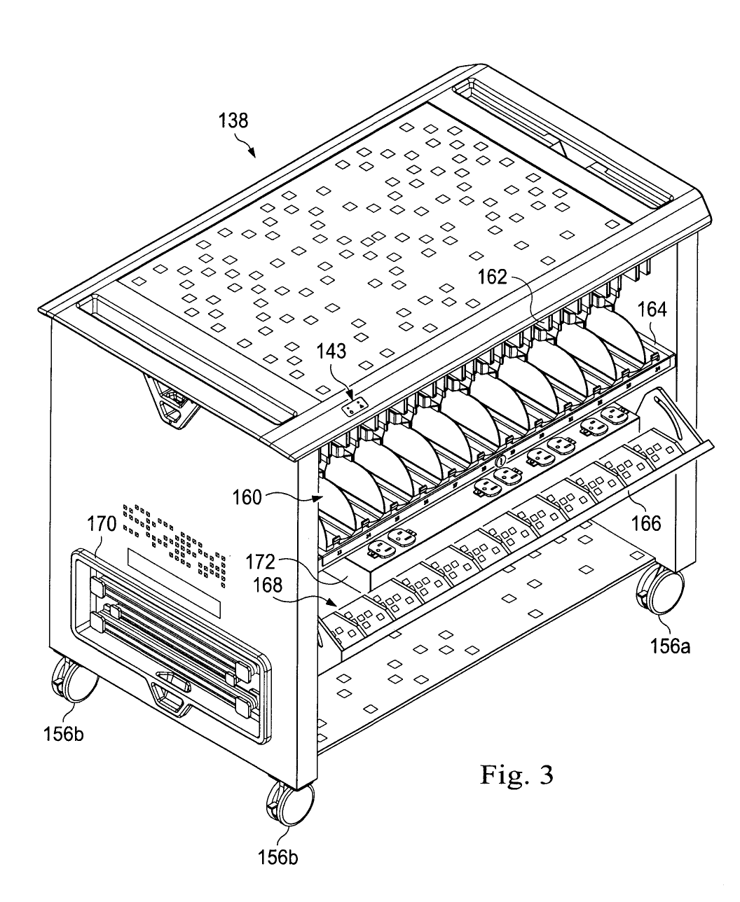

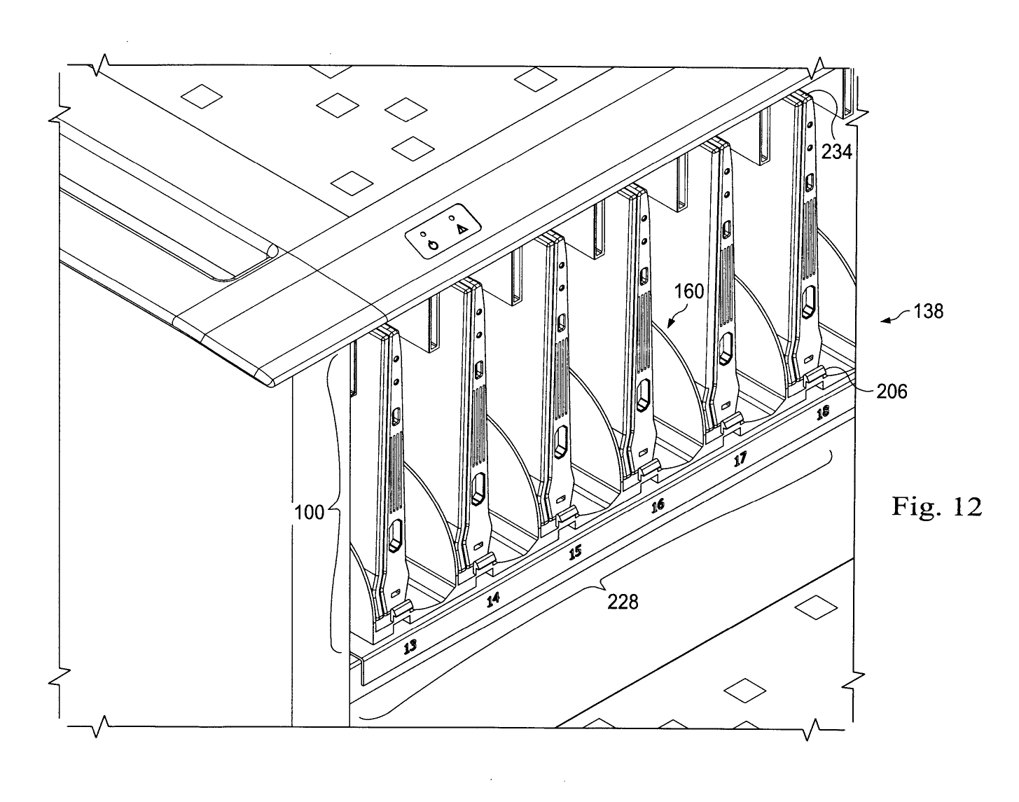

FIG. 3 illustrates an isometric view of the IHS storage cart 138 showing the access doors 146, 148 in an open position. Inside the upper portion of the cart is one or more docking stations 160. The docking station 160 is formed using molded plastic, such as PC/ABS FR Resin (5V rated). The form of the docking station 160 includes channels configured to match an outer form of the portable IHSs 100 to prevent a user from inserting the IHSs 100 the wrong way into the docking station 160. A nylon/plastic notebook key device 162 may be incorporated into each of the channels to help guide the user to the channel for docking the IHSs 100. Using the channels in the docking station 160 a user may dock and un-dock the IHS 100 from the docking station 160 using just one hand to hold the IHS 100 to the channel and slide the IHS into the channel. A tab located at a front portion of each dock channel ensures positive seating of power and network connectors with the IHSs 100. In an embodiment, the tab is colored (e.g., green) and located in the channel at a distance from the back of the channel approximately the same as the width of the IHS shell, which indicates to the user that the IHS is properly seated in the docking station 160 for charging when the user sees the colored tab. Docking the IHSs 100 into the docking station 160 may be performed by opening the top compartments by opening the door 146. Opening the door 146 includes unlocking door 146, lifting the door up and out (to clear a holding tab), allowing the door 146 to drop slightly, then lift up and slide the door under upper work surface 144. The user may then insert the IHSs 100 into the channels with front edge of IHSs 100 upward and power/Ethernet connectors on the IHS 100 leading into the channel. The colored tab at the front of the dock channel will be visible to the user if the IHS 100 has been properly seated in the channel. Charging and maintenance data for the IHS 100 can be indicated at the top, outer corner of each IHS 100 when it is docked in the docking station 160 (see also FIG. 12).

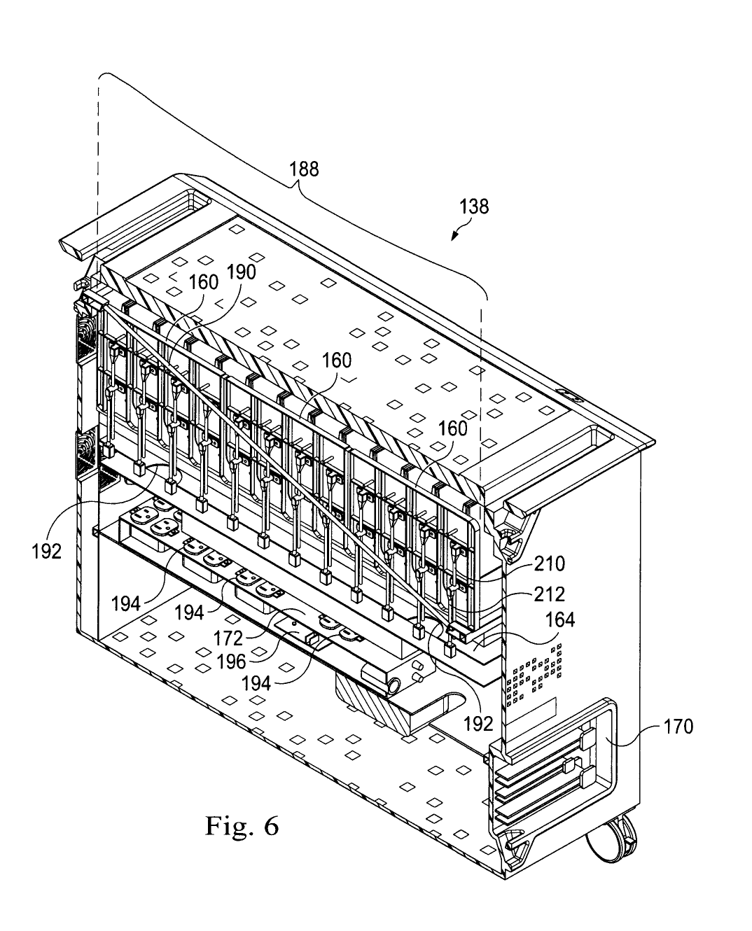

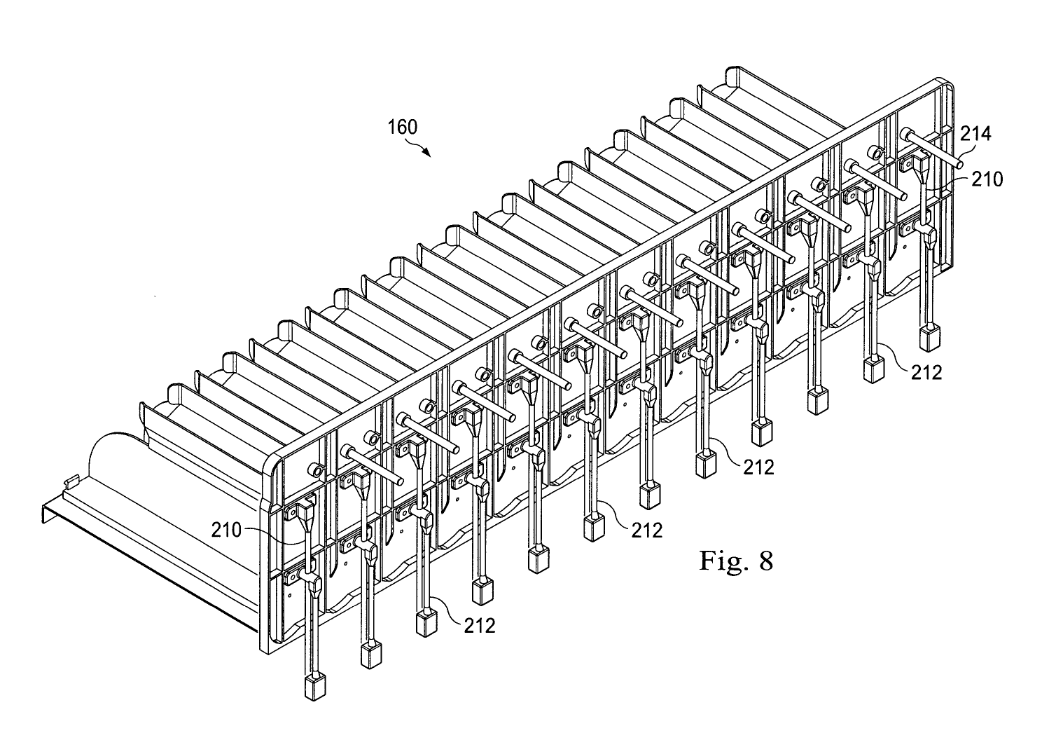

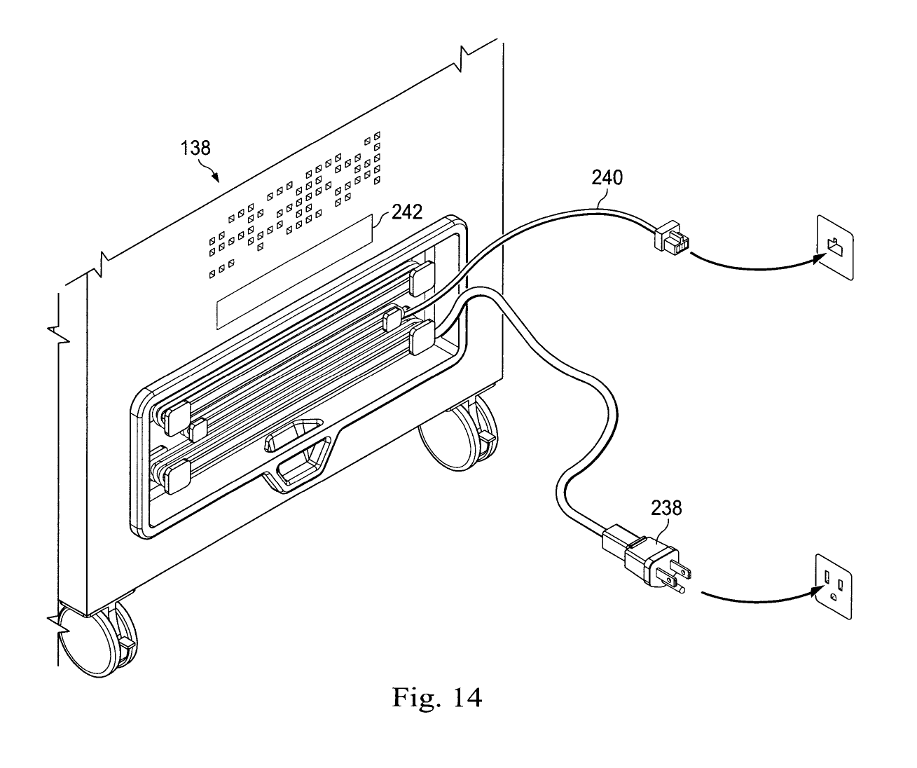

FIG. 3 also shows that the docking station 160 is supported by a top compartment shelf 164 portion of the cart 138 frame. Below the top compartment shelf 164 is a lower compartment shelf 166. The shelves 164, 166 are formed from sheet steel, painted or powder coated, and attached or otherwise fastened to the side panels 150. The lower compartment door 148 includes a number of molded plastic power adaptor holders 168. The power adaptor holders 168 are configured to mate with and secure standard AC IHS power adapters, such as the Dell UU572 AC adapter, securely to the door 148. The AC plug of the power adapters may be plugged into receptacles 194 on the power supply box 172 (see FIG. 6) and the DC plug of the power adapters is plugged into power dongles (discussed below) on the back side of the docking station 160 (see also FIGS. 6 and 8). The cart 138 also includes an external cable management bay 170 on one end side panel 150. The cable management bay is formed using molded plastic and mates with an opening in the side panel 150. The cable management bay 170 provides a holding area for an AC power cord (see FIG. 14) that receives power from a wall electrical outlet and transfers that power to the power supply box for distribution to the IHSs 100 and other electrical components in the cart 138. Additionally, the cable management bay 170 provides a holding area for an Ethernet or other data communication cable (see FIG. 14) that receives data communication signals from a wall network outlet and transfers the communication signals to the IHSs 100 and other communication components in the cart 138.

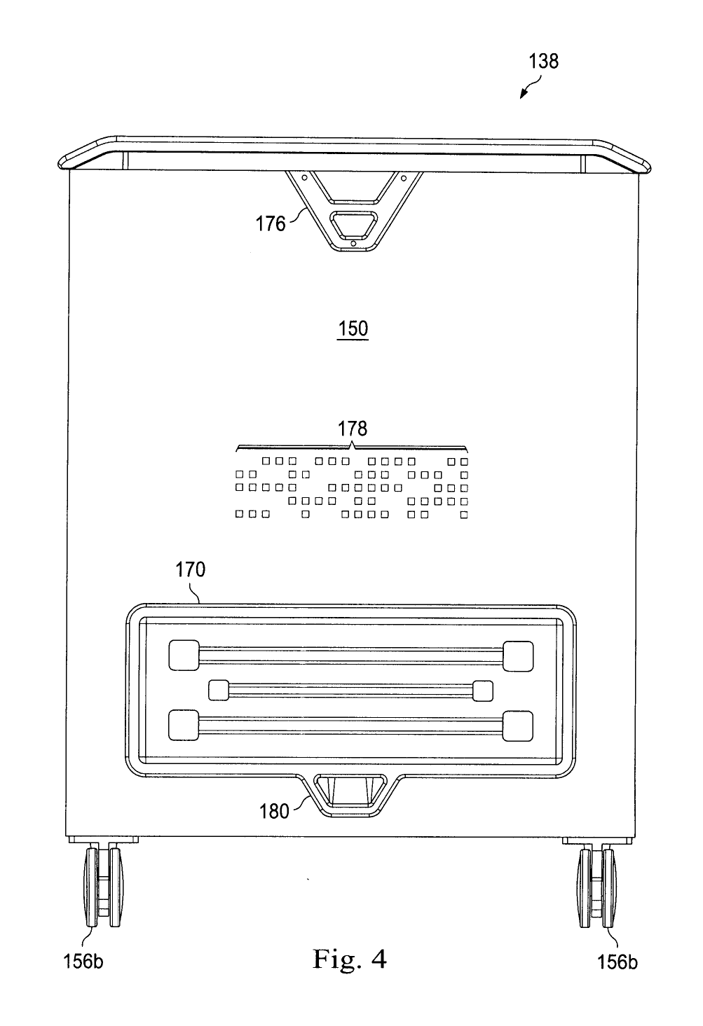

FIG. 4 illustrates an isometric end view of an end of the cart 138. This view shows the side panel 150, the casters 156b, and the cable management bay 170. This view also shows lower compartment vent holes 178 formed through the side panel 150. These holes 178 allow cooling and ventilation for the components stored in the lower compartment. In addition, this view shows a theft-deterrent loop 176 and a heavy-duty security loop 180 that may be used for securely attaching the cart to a secure device or structure using a lock, cable, or other securing device.

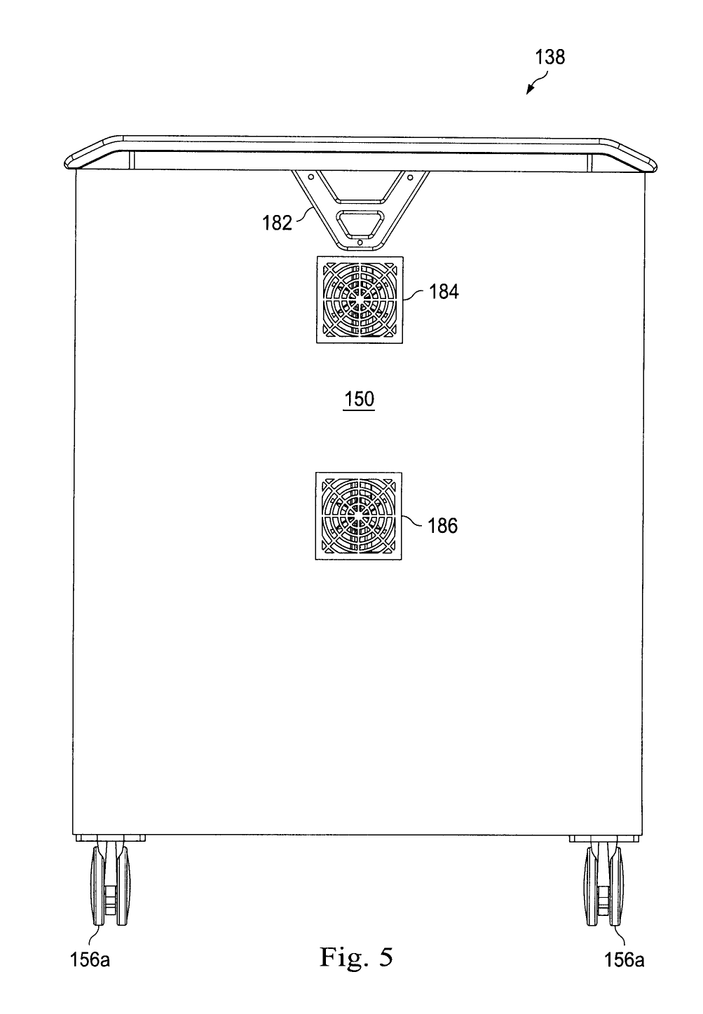

FIG. 5 illustrates an isometric end view of the other end of the cart 138, located opposite of that shown in FIG. 4. This view shows the side panel 150 and the casters 156a. This view also shows another theft-deterrent loop 182 that is substantially similar to the loop 176 discussed above. In addition, this view shows upper compartment cooling fan 184 and lower compartment cooling fan 186. These fans 184 and 184 operate using electrical motors and fan blades to pull through or push air out of the vent holes 149 and/or 178 to provide cooling air for the components housed in the upper and lower compartments. The fans 184 and 186 should be sized to provide adequate air flow for cooling the devices in the cart 138. The fans 184, 186 include vented fan guards to protect people and objects from the spinning fan blades. The fans 184, 186 may be thermostatically controlled to turn on and off as temperature in the respective upper and lower compartments reach set temperature levels.

FIG. 6 illustrates an isometric cut-away view showing the inside of an embodiment of the cart 138. This cut-away view illustrates a rear view 188 of the several docking stations 160, including Ethernet dongle cables 210 and DC power dongle cables 212 for each channel in the docking station 160. The Ethernet dongle 210 is an insulated cable that receives Ethernet communication signals and passes them to a connector in each channels of the docking station 160. The DC power dongle 212 is an insulated cable that receives DC electrical power from the AC power adapters and passes that to a connector in each channel of the docking station 160. FIG. 6 also shows that the cart 138 may include one or more tension rods 190 attached between the side panels 150 to support and stabilize the frame of the cart 138. In addition, the top compartment shelf 164 includes one or more cable pass through channels 192 through the shelf 164. Furthermore, FIG. 6 shows the power supply box 172, including electrical receptacles 194, circuit breakers (not shown), and a controller 196. The circuit breakers provide over current protection for the receptacles 194. In an embodiment, the controller 196 provides sequenced power to the receptacles 194 such that a portion of received electrical power is provide to the various IHSs 100 docked in the docking station 160 over time to provide a small amount of charging to all of the docked IHSs 100 in a short amount of time and then over time all of the docked IHSs 100 are fully charged. In other words, the AC adapters are plugged into the receptacles 194 to receive AC power. The AC adapters are also plugged into the dongles 212 to provide DC power to the docking station channels. As such, as the controller 196 alternates providing AC power to different receptacles 194, the associated power adapters turn on and off to provide charging to the docked IHSs 100 in the docking station 160. This allows for charging to all of the docked IHSs 100 using only a single input AC power cable, such as 238 shown in FIG. 14 without exceeding current requirements for a single wall outlet. The power supply box 172 may also include an Ethernet switching device.

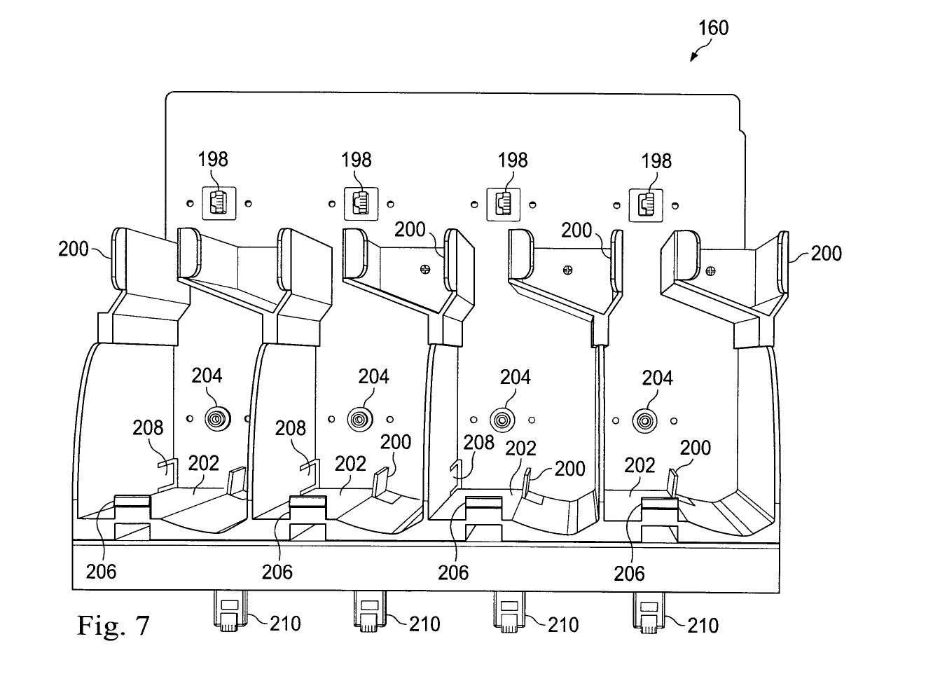

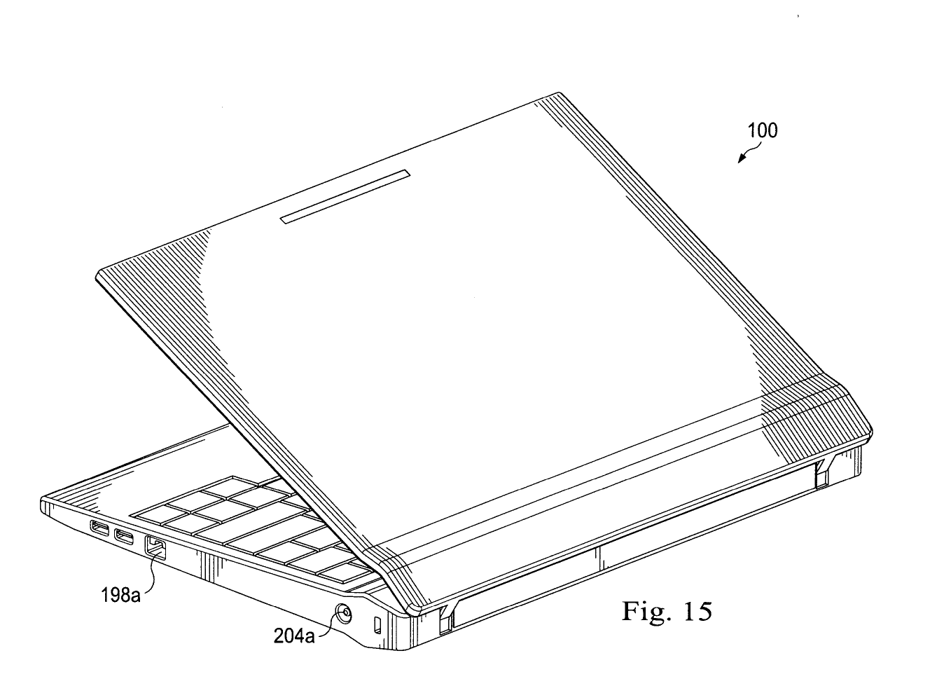

FIG. 7 illustrates an isometric view of an embodiment of the docking station 160. The docking station includes an Ethernet connector 198 for each channel of the docking station 160 extending from a back wall of the docking station 160. The Ethernet connector 198 is communicatively coupled to the Ethernet dongle 210 for passing communication signals to IHSs 100 lined docked in the channels of the docking station 160. In an embodiment, the Ethernet connector 198 conforms to standard RJ-45 connector standards and lines-up with a mating Ethernet connector 198a located on a side portion of the IHSs 100 (see FIG. 15). The channel areas 202 of the docking station 160 are defined by the tapered guides 200. The guides 200 are configured to mate with the outer form of the portable IHSs 100, which are to be docked in the docking station channels 202. These guides 200 may be formed using molded plastic. Also extending from the back wall of the docking station 160 are DC power connectors 204 that line-up with a mating power connector 204a located on the side of the IHSs 100 (see FIG. 15). Accordingly, a user, such as a student, may single handedly insert the IHS 100 into the channel 200, guided by the guides 200, and couple the IHS 100 to the Ethernet connector 198 and the power connector 204 without having to physically connect the IHS 100 to cables. Tabs 206, located at a front portion of each docking station channel 202 ensures positive seating of the communication and power connectors 198 and 204 with the mating connectors of the IHSs 100. In an embodiment, the tabs 206 are colored (e.g., green) and located in the channel area 202 at a distance from the back wall of the docking station 160 approximately the same as the width of the IHS shell. The channel 202 may be recessed to reduce wear on the case of the IHSs 100. This thereby indicates to the user that the IHS 100 is properly seated in the docking station 160 for charging when the user sees the colored tab 206. Adjustable tabs 208 may be provided in the channel area of the docking station 160 to adjust positioning of the IHS 100 in the channel as needed. In an embodiment, the adjustable tabs 208 adjust to accommodate between standard and touch screen IHSs. It is to be understood that the cart 138 may include any number of docking stations 160 and also that each docking station 160 may include any number of channels 202. In addition, it is contemplated that the a first docking station in the cart 138 may be configured to mate with a first model of IHS and a second docking station in the same cart 138 may be configured to mate with a second, different model of IHS.

FIG. 8 illustrates an isometric rear view of the docking station 160. This view shows the Ethernet dongles 210, the power dongles 212 and stability pins 214. The stability pins 214 may be formed using a substantially ridged material. The pins 214 mate with corresponding sockets in the back wall of the docking station 160 and an opposite docking station on a back side of the cart 138. This provides rearward lateral support for the docking station as the IHSs 100 are slid into docking station.

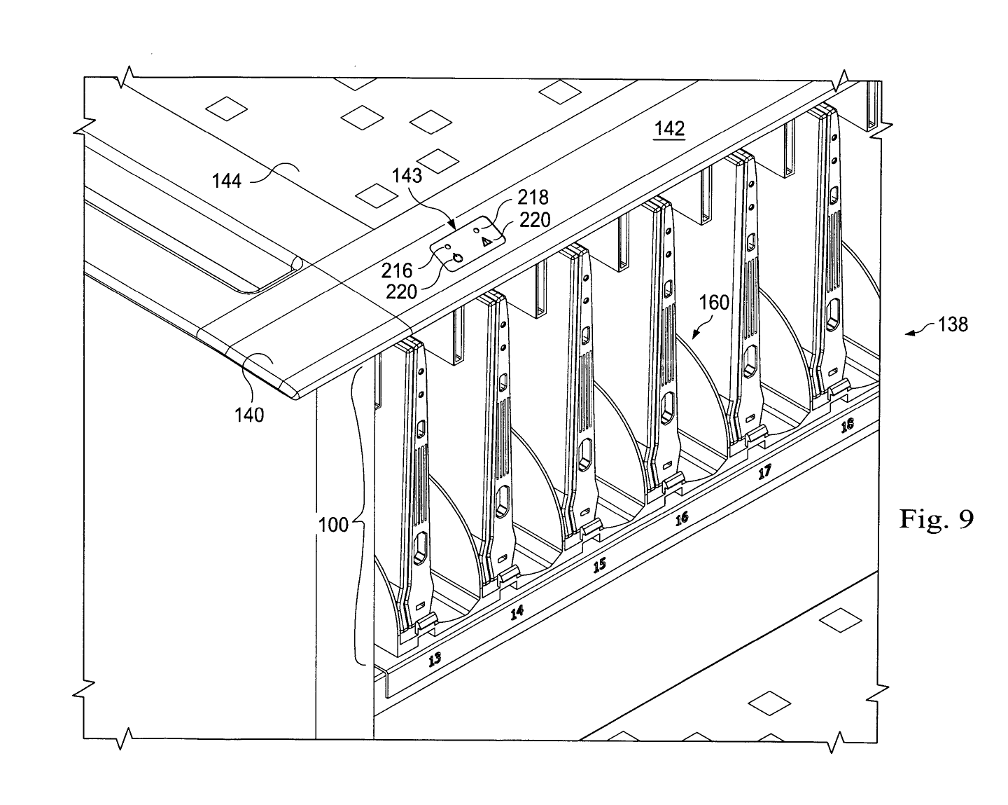

FIG. 9 illustrates a close-up isometric view of a portion of the cart 138, specifically the status indicator 143 on the top cover 142. In an embodiment, the status indicator 143 includes a power light 216, an over temperature light 218, and corresponding symbols 220. The power light 216 indicates that there is electrical power to the cart 138. In an embodiment, the power light 216 is a blue colored light emitting diode (LED). However, other types of indicators may be used. If there fault with the cart, the power light 216 may flash to indicate a problem. In an embodiment, the over temperature light 218 is an amber colored LED that flashes when a pre-determined maximum temperature has been exceeded in either the upper or lower compartment. When the over temperature light 218 is flashing, a user may ensure areas around the fans 184, 186 and vents 149, 178 are unobstructed. In addition a user may take measures to reduce room temperature, such as below 86° F. (32° C.). In this case, the power cord 238 should remain plugged-in so that the fans 184, 186 continue to operate. Once the temperature has dropped to a safe level, charging of the IHSs 100 will resume. It is to be understood that the status indicator may include other indicators and may be another type of indicator, such as a liquid crystal display (LCD) display for displaying textual messages.

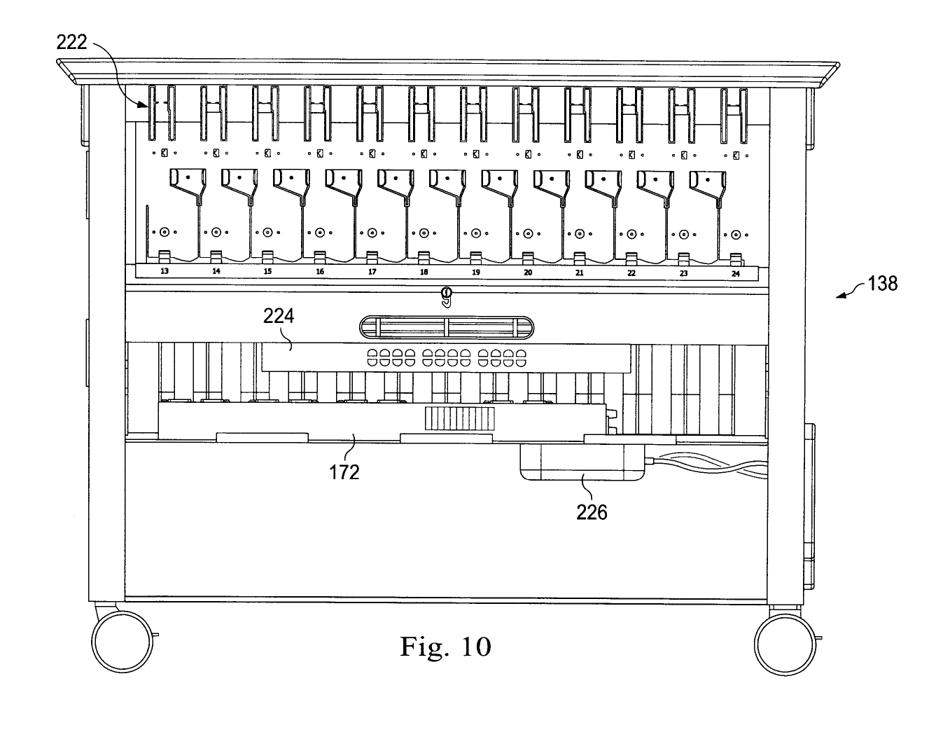

FIG. 10 illustrates another isometric view of an inside portion of the cart 138. This view shows the power supply box 172, an Ethernet switching device 224 and a wireless communication/networking router device 226. The Ethernet switching device 224 is optional and may include a number of ports, such as 24 ports, to communicatively couple with the Ethernet connectors 198 on the docking station 160. In an embodiment, the Ethernet switching device 224 allows remote network updates from remotely located technicians to docked IHSs 100. An example of an Ethernet switching device 224 is a Cisco SR224G, 24 port, 10/100, 2-Port Gigabit Switch+2 mini-GBIC. However, other communication switching devices may be used. The wireless router device 226 is optional and may attach below the lower compartment for easy access. Accordingly, a wire guard may be placed around the router device 226 to protect the router device 226 from damage. An example of a wireless router device 226 is a Linksys WRVS4400N Wireless-N Gigabit Security Router with VPN. However, other router devices may be used. Fit. 10 also illustrates IHS alignment keys 222. The alignment keys 222 may be formed from molded plastic and placed above the docking station to provide a proper alignment for the IHSs 100 when being placed into the docking station 160.

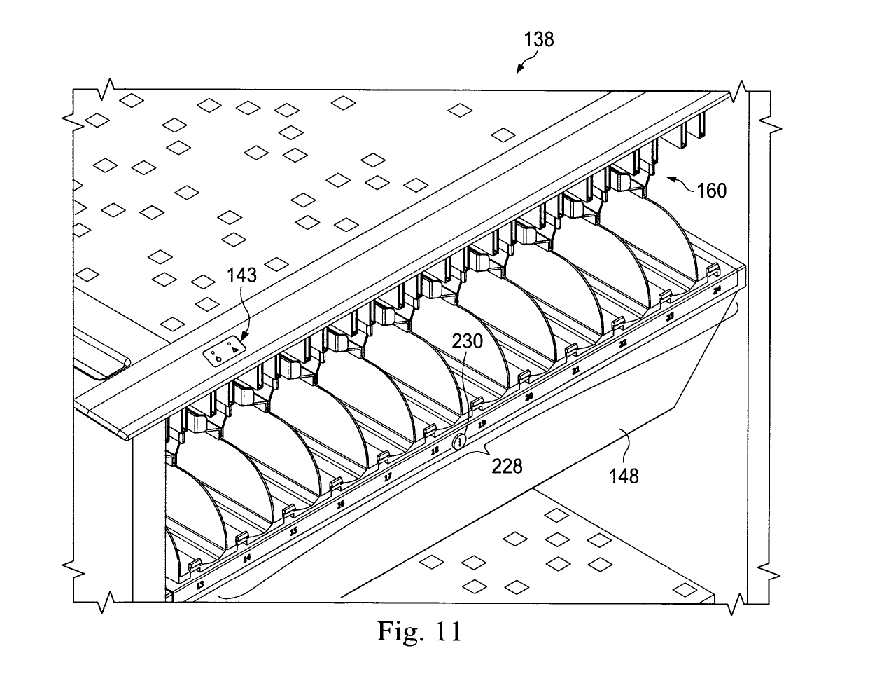

FIG. 11 illustrates an isometric view of an embodiment of the docking station 160 in the cart 138. As shown, the docking station 160 may include numbered dock labels 228 corresponding with each channel 202 of the docking station 160. Using the labels 228, a user may return the IHS 100 they have been using to its proper channel 202. In addition, FIG. 11 shows a keyed lock 230 on the lower compartment door 148.

FIG. 12 illustrates an isometric view of an embodiment of the docking station 160 holding a plurality of IHSs 100 docked in the cart 138. While docked, the Ethernet plug and the power plug for the IHS 100 aligns with the corresponding plug (e.g., 198, 204) on the back wall of the docking station (see FIG. 7). When the IHSs 100 are properly docked in the channels 202 of the docking station 160 and the cart 138 is electrically powered, a charge indicator light 234 on an upper front corner of the IHSs 100 will illuminate to show that the IHS is properly docked and currently charging. Other indicators may also be used with the cart 138 of the present disclosure.

FIG. 13 illustrates an exploded view of handle 140 assembly to the cart 138. In an embodiment, a number of screws 236 or other fasteners are used to attach the handles 140 to the cart 138. However, the handles 140 may be attached differently, formed into the upper surface 144 and/or the side panels 150. In addition, the handles 140 may be omitted from the cart 138. The handles 140 may be positioned at each end of cart 138.

FIG. 14 illustrates an isometric view of cable connections for an embodiment of the cart 138. As should be understood, power cord 238 and network/Ethernet cable 240 may be plugged into corresponding wall outlets to respectively provide electrical power and data/communications to the cart 138. Also shown in FIG. 14 is a label 242 that may affixed to a side panel 150 for providing name, model, serial number, and/or a variety of information about the cart 138. For example, the cart may indicate that the cart 138 is configured to be powered using 120 VAC, 12 A, 60 Hz electrical power. In operation of the cart 138 for docking and charging a plurality of IHSs 100, a user may connect power cord 238 to a dedicated circuit, (e.g., one not shared with other devices), verify that the light 216 on the power/fault status indicator 143 at the work-top is illuminated. Then, the user should allow 2-3 hours for the IHSs 100 to reach a full charge before removing and using the IHSs 100. For monitoring cart 138 status, the user may check the power/fault status indicator lights 143 at the top of the cart 138. When the pre-determined temperature has been exceeded in the compartments, power to the IHSs 100 is terminated until the temperature falls into an acceptable operating range, at which time charging resumes. The charging status of individual IHSs 100 can be seen directly on the IHSs 100 via the charge indicator lights 234 when they are docked and the upper compartment doors 146 are open.

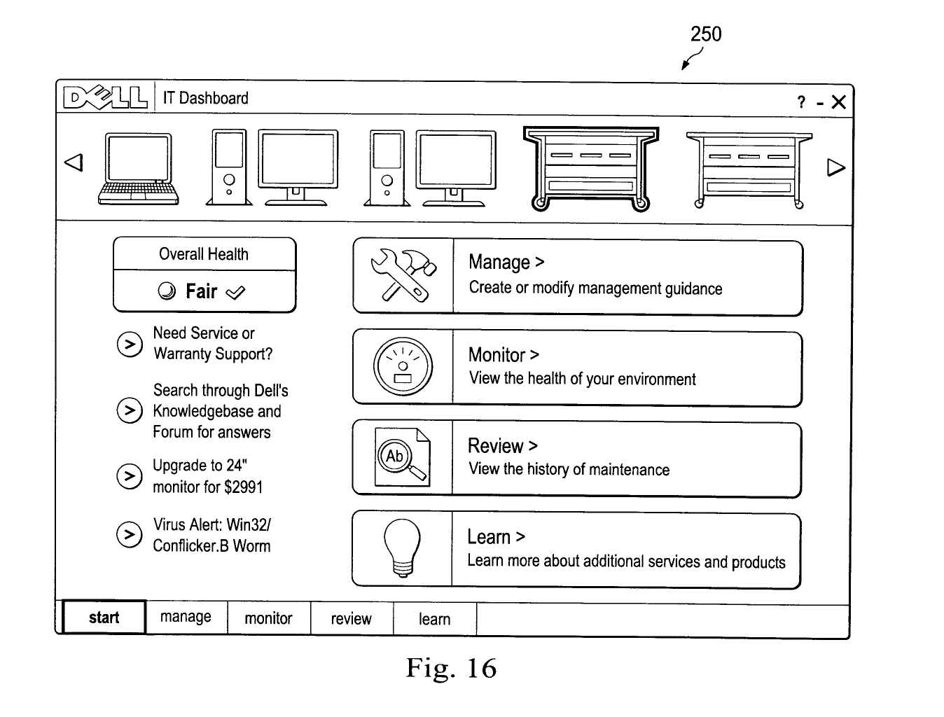

FIG. 16 illustrates a screen shot 250 of an embodiment of a maintenance application that is configured to provide updates to the IHSs 100. The maintenance application allows a local or a remotely located technician to check, update, maintain, provide commands to, receive commands from, or otherwise communicate with the IHSs 100 and/or the cart 138. Using the maintenance application a technician can check the operational status of each IHS 100 docked in the cart 138 and also check the operational status of each IHS 100 not docked in the cart 138 when they are communicating with the cart 138, such as via the router 226. Software updates may be loaded to the cart 138 and/or the IHSs 100 using the maintenance application. A technician may use the application to perform an operation for individual IHSs 100, and for all of the IHSs 100 as a group. In other words, the application allows for any kind of interaction with the cart 138 and/or the IHSs 100.

In an embodiment, physical characteristics of the cart are approximately as follows:
Height: 38.7″ (982.98 mm)
Length: 40″ (1016 mm)
Width: 24″ (609.6 mm)
Weight (without IHSs): 230 lbs (104 kg)
Weight Capacity Top Surface: 25 lbs (11.34 kg)
Weight Capacity Lower Shelf: 25 lbs (11.34 kg)
Tip Test/Angle: 10°

In an embodiment, the cart is configured to operate in an environment of approximately as follows:
Temperature Operating Range: 32° to 86° F. (0° to 30° C.)
Temperature Storage Range: −40° to 149° F. (−40° to 65° C.)
Relative Maximum Operating Humidity: 10-90% (non condensing)
Relative Maximum Storage Humidity: 5-95% (non condensing)
Maximum Altitude: 6,562 ft (2000 m)

As should be readily understood by those having ordinary skill in the art, the cart 138 of the present disclosure solves numerous problems around securing, managing/updating, storing, charging and networking of IHSs 100 in a classroom or other setting. In an embodiment, the design of the present disclosure provides for WoL updating of a number of (e.g., 24) IHSs 100, quick charging (e.g., 80% from 0 in 1 hour), and speeds the development and stowage, allowing more time for learning tasks in the classroom for both the student and teacher.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A portable information handling system (IHS) storage device comprising:
a frame;
a docking station supported by the frame, wherein the docking station includes a plurality of channels configured to receive a plurality of portable IHSs, and wherein the channels include a power coupling and a communication coupling, wherein the power coupling and the communication coupling are configured and positioned to mate with corresponding power and communication couplings of the plurality of portable IHSs when the plurality of IHSs are engaged in the plurality of channels;
a power supply system supported by the frame and electrically coupled to the power coupling(s), the power supply system configured to provide staged charging when a plurality of portable IHSs are stored in the docking station; and
a communication switching system supported by the frame and communicatively coupled to the communication coupling(s) such that the communication coupling(s) provide communication signals to the plurality of portable IHSs when stored in the docking station.

2. The storage device of claim 1, wherein the power supply system is configured to provide the staged charging using a single incoming power cable.

3. The storage device of claim 1, wherein the frame includes a lockable door is configured to limit access to the docking station when closed and locked.

4. The storage device of claim 1, further comprising:
a router device supported by the frame and configured to provide wireless communication signals to the portable IHSs.

5. The storage device of claim 1, wherein the communication switching system is configured to communicate administrator communications to the plurality of IHSs when stored in the docking station.

6. The storage device of claim 1, further comprising:
a second docking station supported by the frame substantially opposite the docking station, thereby allowing IHS storage on opposite sides of the frame.

7. The storage device of claim 1, wherein the communication signals are Ethernet communication signals.

8. A computing and storage system comprising:
a plurality of portable information handling systems (IHSs), the plurality of IHSs each including:
a shell;
a processor within the shell;
a memory device communicatively coupled to the processor; and
a display device; and
a storage cart, the storage cart including:
a frame;
a docking station supported by the frame, wherein the docking station includes a plurality of channels configured to receive the plurality of portable IHSs, and wherein the channels include a power coupling and a communication coupling, wherein the power coupling and the communication coupling are configured and positioned to mate with corresponding power and communication couplings of the plurality of portable IHSs when the plurality of IHSs are engaged in the plurality of channels;
a power supply system supported by the frame and electrically coupled to the power coupling(s), the power supply system configured to provide staged charging when a plurality of portable IHSs are stored in the docking station; and
a communication switching system supported by the frame and communicatively coupled to the communication coupling(s) such that the communication coupling(s) provide communication signals to the plurality of portable IHSs when stored in the docking station.

9. The system of claim 8, wherein the power supply system is configured to provide the staged charging using a single incoming power cable.

10. The system of claim 8, wherein the frame includes a lockable door is configured to limit access to the docking station when closed and locked.

11. The system of claim 8, further comprising:
a router device supported by the frame and configured to provide wireless communication signals to the portable IHSs.

12. The system of claim 8, wherein the communication switching system is configured to communicate administrator communications to the plurality of IHSs when stored in the docking station.

13. The system of claim 8, further comprising:
a second docking station supported by the frame substantially opposite the docking station, thereby allowing IHS storage on opposite sides of the frame.

14. The system of claim 8, wherein the communication signals are Ethernet communication signals.

15. A portable information handling system (IHS) storage cart comprising:
an enclosable frame;
a first docking station supported by the frame, wherein the docking station includes a plurality of channels configured to receive a plurality of portable IHSs, and wherein the channels include a power coupling and a communication coupling, wherein the power coupling and the communication coupling are configured and positioned to mate with corresponding power and communication couplings of the plurality of portable IHSs when the plurality of IHSs are engaged in the plurality of channels;
a second docking station supported by the frame substantially opposite the first docking station, thereby allowing IHS storage on opposite sides of the frame, the second docking station including a plurality of channels configured to receive a plurality of portable IHSs, and wherein the channels include a power coupling and a communication coupling, wherein the power coupling and the communication coupling are configured and positioned to mate with corresponding power and communication couplings of the plurality of portable IHSs when the plurality of IHSs are engaged in the plurality of channels;
a power supply system supported by the frame and electrically coupled to the power coupling(s), the power supply system configured to provide staged charging when a plurality of portable IHSs are stored in the docking station; and
a communication switching system supported by the frame and communicatively coupled to the communication coupling(s) such that the communication coupling(s) provide communication signals to the plurality of portable IHSs when stored in the docking station.

16. The storage cart of claim 15, wherein the power supply system is configured to provide the staged charging using a single incoming power cable.

17. The storage cart of claim 15, wherein the frame includes a lockable doors configured to limit access to the first and second docking stations when closed and locked.

18. The storage cart of claim 15, further comprising:
a router device supported by the frame and configured to provide wireless communication signals to the portable IHSs.

19. The storage cart of claim 15, wherein the communication switching system is configured to communicate administrator communications to the plurality of IHSs when stored in the docking station.

20. The storage cart of claim 15, wherein the communication signals are Ethernet communication signals.
